(19) United States
(12) Patent Application Publication
(10) Pub. No.: US 2024/0334218 A1
(43) Pub. Date: Oct. 3, 2024

(54) SYSTEM FOR GENERATING INFORMATION RELATING TO COMMUNICATION POSSIBILITY, AND TERMINAL DEVICE

(71) Applicant: toraru Co., Ltd., Kobe-shi, Hyogo (JP)

(72) Inventor: Jun NISHIGUCHI, Kobe (JP)

(21) Appl. No.: 18/274,795

(22) PCT Filed: Dec. 15, 2021
(86) PCT No.: PCT/JP2021/046178

§ 371 Date: Jan. 31, 2024

(30) Foreign Application Priority Data
Jan. 29, 2021 (JP) 2021-013681

(51) Int. Cl. H04W 24/08; H04W 64/00

(52) U.S. Cl. CPC H04W 24/08; H04W 64/00

(57) ABSTRACT

A system is provided for enabling a user to know, using a terminal device, what quality of data can be transmitted to a communication partner device in real time in a specific area. The system stores correspondence data indicating the correspondence between a quality of data to be communicated and a communication speed required to communicate data having the quality in real time. The system receives position data from various terminal devices indicating the current position of each of the terminal devices, measures a communication speed in data communications made with each of the terminal devices at the position indicated by the position data, and generates communication speed data indicating the results of the measurements. Based on the position data, communication speed data and correspondence data, the system generates communication possibility data indicating what quality of data, in which area, can be communicated in real time with the system by a terminal device.

### TECHNICAL FIELD

The present invention relates to a technique for generating information relating to possibility of data communication via communication networks.

### BACKGROUND ART

A communication speed in data communication via communication networks varies depending on various environmental factors in which the communication networks are located. Those environmental factors include a number of data communication devices using the communication networks, an amount of data being communicated via the communication networks, and a state of a communication medium of the communication networks such as wireless, etc.

A user of the communication networks may want to know a communication speed when communicating data with a specific party. In particular, when data communication is performed by wireless communication, the communication speed varies greatly depending on a user's location, and many users need to know at what speed data communication can be performed at a specific location.

In addition, telecommunication carriers that provide wireless communications need to identify areas with slow communication speeds (including areas with zero communication speeds, i.e., areas where communication is not possible) in order to improve the quality of communication services. When telecommunication carriers can identify areas with slow communication speeds, they can improve the quality of communication services in those areas by installing antennas for wireless communication (wireless base stations) within those areas.

As a technology to satisfy the above needs, for example, Patent Document 1 proposes a system in which, during movement of a mobile body equipped with a communication device and a position measuring device, a radio wave strength during communication with a specific party by wireless communication is measured by the communication device, a position of the mobile body is measured by the position measuring device, data indicating the measured radio wave strength and the measured position of the mobile body are transmitted to an information processing device, and a map indicating the radio wave strength (communication state) at each section along the moving path of the mobile body is generated by the information processing device.

### PRIOR ART DOCUMENT

### Patent Document

Patent Document 1: JP2019-195145A

### Problem to be Solved by the Invention

Many people have experienced a situation in which they want to go to a certain place but are unable to do so for various reasons, and therefore want someone else to go there on their behalf and report back to them on the status of the place.

On the other hand, wireless communication technology has become widespread in recent years, and many people carry personal computers equipped with wireless communication and calling functions, known as smartphones. Many smartphones are equipped with sophisticated cameras and microphones, and while generating video data with sound that represents an image captured by the camera and sound picked up by the microphone, the generated video data with sound (hereinafter referred to as “video data captured by a smartphone”) can be sequentially transmitted to data communication devices in remote locations via wireless communication networks.

Under the above circumstances, a user who makes a request (hereinafter referred to as a “client user”) recruits people to go to places where he/she is unable to go on behalf of the client user, and a user who responds to the request (hereinafter referred to as an “agent user”) goes to the place specified by the client user and sends video data captured by his/her smartphone to the client user's terminal device in real time, thereby satisfying the client user's needs. The above service is hereinafter referred to as an “on-site agency service.”

In the above on-site agency service, if the wireless communication environment at the site (a location designated by the client user) is poor, the communication speed may not be sufficient at the site, and the agent user's smartphone may not be able to transmit video data having the quality demanded by the client user in real time. In that case, the client user's objective is not achieved. Therefore, users of on-site agency services (client users and agent users) need to know what quality of video data can be transmitted in real-time at the site before video recording is performed at the site.

In view of the above circumstances, the present invention provides a means by which a user can know, using a terminal device, what quality of data can be transmitted to a designated data communication device in real time in a particular area.

### SUMMARY

The present invention provides, as a first aspect, a system comprising: a storage means for storing correspondence data indicating a correspondence between a quality of data to be communicated and a communication speed required to communicate data having the quality in real time; an acquisition means for acquiring position data indicating a position of a terminal device and communication speed data indicating a communication speed in data communications made by a terminal device at a position indicated by the position data with a communication partner device; and a generating means for generating communication possibility data indicating a quality of data that can be communicated in real time, and in which area, between a terminal device and a communication partner device based on the position data, the communication speed data corresponding to the position data, and the correspondence data.

With the system according to the first aspect, a user can use the terminal device to know what quality of data, in which area, can be transmitted in real time to a designated communication partner device.

In the system according to the first aspect, it is also possible to adopt, as a second aspect, a configuration further comprising: a communication means for data communicating with a terminal device, wherein the communication speed data acquired by the acquisition means indicates a communication speed in data communications made by the communication means with a terminal device at a position indicated by the position data.

With the system according to the second aspect, a quality of data that can be transmitted in real time from the terminal device to the communication partner device via the system is specified with high accuracy.

In the system according to the first or second aspect, it is also possible to adopt, as a third aspect, a configuration in which the acquisition means acquires, in addition to the position data and the communication speed data corresponding to the position data, time data indicating a time when a terminal device at a position indicated by the position data communicated with a communication partner device at a communication speed indicated by the communication speed data, and the generating means generates the communication possibility data for each of a plurality of time periods that divide one day based on the time data.

With the system according to the third aspect, even if a communication speed varies at different times of a day, a user can use the terminal device to know what quality of data, in which area, can be transmitted to the designated communication partner device in real time.

In the system according to the third aspect, it is also possible to adopt, as a fourth aspect, a configuration in which the storage means stores calendar data indicating a date, a day of a week, and whether the date is a holiday or not, and the generating means generates the communication possibility data for each day of a week and whether each day is a holiday or not based on the calendar data.

With the system according to the fourth aspect, even if a communication speed varies depending on a day of a week and whether it is a holiday or not, a user can use the terminal device to know what quality of data can be transmitted to the designated communication partner device in real time in a specific area.

In the system according to the second aspect, it is also possible to adopt, as a fifth aspect, a configuration in which the communication means receives from a server device weather data indicating weather at a position indicated by the position data at a time indicated by the time data corresponding to the position data, and the generating means generates the communication possibility data for each type of weather based on the weather data.

With the system according to the fifth aspect, even if a communication speed varies depending on weather, a user can use the terminal device to know what quality of data can be transmitted to the designated communication partner device in real time in a specific area.

In the system according to any one of the first to fourth aspects, it is also possible to adopt, as a sixth aspect, a configuration in which the acquisition means acquires, in addition to the position data and the communication speed data corresponding to the position data, communication environment data indicating communication environment parameters including at least one of a model of a terminal device at a position indicated by the position data, a type of communication medium used for data communication between a terminal device and a communication partner device at a communication speed indicated by the communication speed data, a carrier providing a communication line used for the data communication, a provider of connection services to the Internet in the data communication, and a type of communication protocol used in the data communication.

With the system according to the sixth aspect, even if a communication speed varies depending on a communication environment, a user can use the terminal device to know what quality of data can be transmitted to the designated communication partner device in real time in a specific area.

In the system according to any one of the first to sixth aspects, it is also possible to adopt, as a seventh aspect, a configuration in which the correspondence data indicates a correspondence between a quality of data to be communicated, a communication speed required to communicate data with the quality in real time, and a communication stability index indicating communication stability required for real-time communication of data having the quality, the acquisition means continuously acquires position data and communication speed data corresponding to the position data for a same terminal device, and the generating means calculates the communication stability index for each area for the same terminal device based on the communication speed data corresponding to the position data indicating a position in each area, and generates the communication possibility data based on the correspondence data and the communication stability index.

With the system according to the seventh aspect, even if a quality of data that can be transmitted in real time varies depending on communication stability, a user can use the terminal device to know what quality of data can be transmitted in real time to a designated communication partner device in a specific area.

In the system according to any one of the first to seventh aspects, it is also possible to adopt, as an eighth aspect, a configuration in which the generating means has a learning model constructed by machine learning using training data including position data as an explanatory variable and communication speed data as an objective variable, and generates the communication possibility data using communication speed data output by the learning model as an objective variable when position data acquired by the acquisition means is input to the learning model as an explanatory variable.

With the system according to the eighth aspect, even if there are areas where position data and communication speed data corresponding to the position data cannot be obtained from the terminal device, it is possible to know what quality of data can be transmitted in real time in the area.

The present invention also provides, as a ninth aspect, a system comprising:

a storage means for storing communication possibility data indicating what quality of data can be communicated in real time between a terminal device in a specific area and a communication partner device, a receiving means for receiving position data from a terminal device indicating a position, an identifying means for identifying a quality of data that can be communicated in real time with a communication partner device by a terminal device at a position indicated by the position data received by the receiving means based on the communication possibility data, and a transmitting means for transmitting quality data indicating the quality identified by the identifying means to a terminal device from which the position data received by the receiving means is transmitted.

With the system according to the ninth aspect, a user of the terminal device can know in which areas data of what quality can be communicated in real time with a communication partner device.

In the system according to the ninth aspect, it is also possible to adopt, as a tenth aspect, a configuration in which the storage means stores a plurality of sets of the communication probability data according to contents of communication environment parameters, the communication environment parameters including at least one of a model of a terminal device, a type of communication medium used for data communication between the terminal device and a communication partner device, a carrier providing a communication line used for the data communication, a provider of connection services to the Internet in the data communication, and a type of communication protocol used in the data communication, the receiving means receives communication environment data indicating contents of communication environment parameters of a terminal device from which the position data is transmitted, and the identifying means identifies the quality based on the communication possibility data corresponding to contents of communication environment parameters indicated by the communication environment data received by the receiving means.

With the system according to the tenth aspect, depending on a communication environment of the terminal device, a quality of data that can be communicated in real time is more accurately specified.

The present invention also provides, as an eleventh aspect, a system comprising: a storage means for storing communication possibility data indicating what quality of data can be communicated in real time between a terminal device in a specific area and a communication partner device, a receiving means for receiving, from a terminal device, position data indicating a position and quality data indicating a quality of data that the terminal device wishes to communicate in real time with a communication partner device, a determining means for determining, based on the communication possibility data, whether or not the terminal device can communicate data of a quality indicated by the quality data with a communication partner device in real time at a position indicated by the position data, and a transmitting means for transmitting determination result data indicating a result of determination made by the determining means to a terminal device from which the position data and quality data received by the receiving means are transmitted.

With the system according to the eleventh aspect, a user of the terminal device can know whether or not the desired quality of data can be communicated in real time with a communication partner device at a specific position.

In the system according to the eleventh aspect, it is also possible to adopt, as a twelfth aspect, a configuration in which the storage means stores a plurality of sets of the communication probability data according to contents of communication environment parameters, the communication environment parameters including at least one of a model of a terminal device, a type of communication medium used for data communication between the terminal device and a communication partner device, a carrier providing a communication line used for the data communication, a provider of connection services to the Internet in the data communication, and a type of communication protocol used in the data communication, the receiving means receives communication environment data indicating contents of communication environment parameters of a terminal device from which the position data is transmitted, and the determining means makes the determination based on the communication possibility data corresponding to contents of communication environment parameters indicated by the communication environment data received by the receiving means.

With the system according to the twelfth aspect, depending on a communication environment of the terminal device, it can be determined more accurately whether or not it is possible to communicate data of a specified quality in real time at a specific position.

The present invention also provides, as a thirteenth aspect, a terminal device communicating with the system according to the first aspect, comprising: a communication means for receiving insufficient area data indicating areas with insufficient communication speed data being obtained by the system, a storage means for storing the insufficient area data, a position measuring means for measuring a position of the terminal device, and a determining means for determining whether or not a position of the terminal device measured by the position measuring means is included in an area indicated by the insufficient area data, wherein, when the determining means determines that the position of the terminal device is included in an area indicated by the insufficient area data, the communication means transmits position data indicating the position of the terminal device measured by the position measuring means to the system, and makes data communications with the system to measure a communication speed with the system.

With the terminal device according to the thirteenth aspect, the system can acquire communication speed data for areas where communication speed data is insufficient.

In the terminal device according to the thirteenth aspect, it is also possible to adopt, as a fourteenth aspect, a configuration further comprising: a notifying means for notifying, when the determining means determines that the position of the terminal device is included in an area indicated by the insufficient area data, a grant of benefit.

With the terminal device according to the fourteenth aspect, a user of the terminal device is prompted to go to areas where communication speed data is insufficient, and the system can acquire communication speed data for the areas.

The present invention also provides, as a fifteenth aspect, a program for causing a computer to execute: storing correspondence data indicating a correspondence between a quality of data to be communicated and a communication speed required to communicate data with the quality in real time; acquiring position data indicating a position of a terminal device and communication speed data indicating a communication speed in data communications made by a terminal device at a position indicated by the position data with a communication partner device; and generating communication possibility data indicating what quality of data can be communicated in real time in which area between a terminal device and a communication partner device based on the position data, the communication speed data corresponding to the position data, and the correspondence data.

With the program according to the fifteenth aspect, the system according to the first aspect is realized by a computer.

The present invention also provides, as a sixteenth aspect, a program for causing a computer to execute: storing communication possibility data indicating what quality of data can be communicated in real time between a terminal device in a specific area and a communication partner device, receiving position data indicating a position from a terminal device, identifying a quality of data that can be communicated in real time between a terminal device at a position indicated by the position data and a communication partner device based on the communication possibility data, and transmitting quality data indicating the identified quality of data to a terminal device from which the position data is transmitted.

With the program according to the sixteenth aspect, the system according to the ninth aspect is realized by a computer.

The present invention also provides, as a seventeenth aspect, a program for causing a computer to execute: storing communication possibility data indicating what quality of data can be communicated in real time between a terminal device in a specific area and a communication partner device, receiving, from a terminal device, position data indicating a position and quality data indicating a quality of data that the terminal device wishes to communicate in real time with a communication partner device, determining, based on the communication possibility data, whether or not the terminal device can communicate data of a quality indicated by the quality data with a communication partner device in real time at a position indicated by the position data, and transmitting determination result data indicating a result of the determination to a terminal device from which the position data and quality data are transmitted.

With the program according to the seventeenth aspect, the system according to the eleventh aspect is realized by a computer.

The present invention also provides, as an eighteenth aspect, a program for causing a computer communicating with the system according to the first aspect to execute: receiving insufficient area data indicating areas with insufficient number of communication speed data being obtained by the system, storing the insufficient area data, measuring a position of the computer, determining whether or not the measured position of the computer is included in an area indicated by the insufficient area data, and when it is determined that the position of the computer is included in an area indicated by the insufficient area data, transmitting position data indicating the measured position of the computer to the system, and making data communications with the system to measure a communication speed with the system.

With the program according to the eighteenth aspect, the terminal device according to the thirteenth aspect is realized by a computer.

### BRIEF DESCRIPTION OF THE DRAWINGS

FIG. 1 is a diagram showing an overall configuration of a system according to an embodiment.

FIG. 2 is a diagram showing a configuration of a computer used as a server device according to an embodiment.

FIG. 3 is a diagram showing a functional configuration of a system according to an embodiment.

FIG. 4 is a diagram showing a data structure of correspondence data according to an embodiment.

FIG. 5 is a diagram showing a data structure of a log table according to an embodiment.

FIG. 6 is a diagram showing a data structure of a communication possibility table according to an embodiment.

FIG. 7 is a diagram showing a data structure of a working table according to an embodiment.

FIG. 8 is a diagram showing a data structure of a user table according to an embodiment.

FIG. 9 is a diagram showing a configuration of a computer used as a terminal device according to an embodiment.

FIG. 10 is a diagram showing a functional configuration of a terminal device according to an embodiment.

FIG. 11 is a diagram showing a data structure of an insufficient area table according to an embodiment.

FIG. 12 is a diagram showing a rare-character-appearance-area-map screen displayed by a terminal device according to an embodiment.

FIG. 13 is a diagram showing a granted-benefit-notification screen displayed by a terminal device according to an embodiment.

FIG. 14 is a diagram showing a request-reception screen displayed by a terminal device according to an embodiment.

FIG. 15 is a diagram showing a determination-result-notification screen displayed by a terminal device according to an embodiment.

FIG. 16 is a diagram showing a recruitment-notification screen displayed by a terminal device according to an embodiment.

FIG. 17 is a diagram showing a screen displayed by a terminal device according to a modified embodiment.

### DETAILED DESCRIPTION

### Embodiment

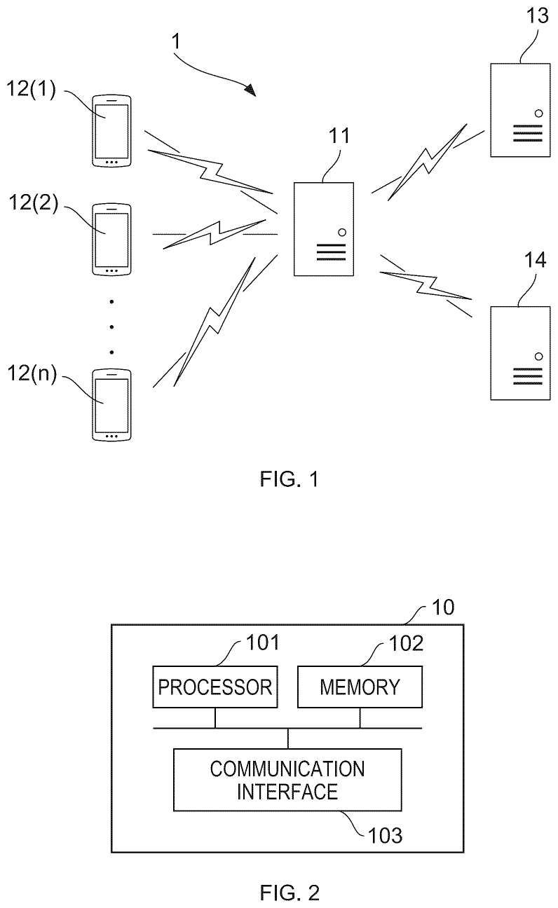

System 1 according to an embodiment of the present invention will be described hereinafter. System 1 is a system that serves as a platform for on-site agency services. FIG. 1 is a diagram showing an overall configuration of System 1. System 1 comprises System 11, which performs a fundamental role of System 1, n (where n is an arbitrary natural number) Terminal Devices 12(1)˜12(n) that perform data communication with System 11, Server Device 13 that distributes weather data, and Server Device 14 that performs a route search.

When n Terminal Devices 12(1)˜12(n) do not need to be distinguished from each other, they are collectively referred to as Terminal Device 12. Terminal Device 12 is a terminal device used by a user of System 1. Therefore, a number of Terminal Devices 12 comprising System 1 changes depending on a number of users of System 1.

System 11 consists of one or more server devices that operate in conjunction with each other. The following is an example of a case where System 11 consists of a single server device. The server device comprising System 11 is realized by a general computer for a server device. FIG. 2 is a diagram showing a configuration of Computer 10 used as the server device comprising System 11. Computer 10 comprises Processor 101, which performs various data processing according to a program, Memory 102, which stores various data including the program, and Communication Interface 103, which performs data communication with other data communication devices.

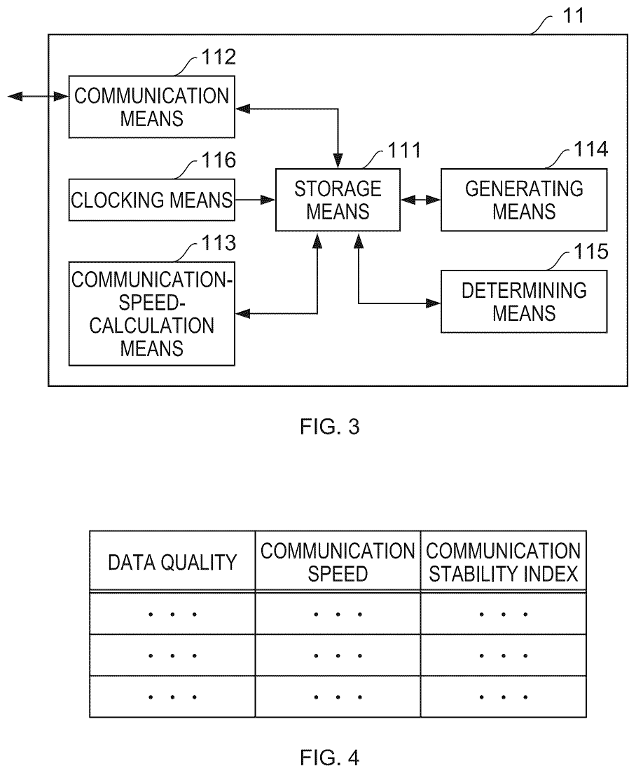

FIG. 3 is a diagram showing a functional configuration of System 11. System 11 with the functional configuration shown in FIG. 3 is realized by Processor 101 of Computer 10, which performs data processing according to the program for System 11. The functional components of System 11 are described below.

Storage Means 111 is a functional component realized by Memory 102, which operates under the control of Processor 101. Storage Means 111 stores various types of data.

Communication Means 112 is a functional component realized by Communication Interface 103, which operates under the control of Processor 101. Communication Means 112 communicates various data with other data communication devices, such as Terminal Devices 12, Server Device 13, and Server Device 14. In this embodiment, Communication Means 112 serves as an acquisition means to acquire position data indicating a position of Terminal Device 12 from Terminal Device 12.

Communication-Speed-Calculation Means 113 is a functional component realized by Processor 101. Communication-Speed-Calculation Means 113 calculates a communication speed in communications made between Communication Means 112 and Terminal Device 12. In this embodiment, Communication-Speed-Calculation Means 113 serves as an acquisition means to acquire communication speed data indicating communication speed.

Generating Means 114 is a functional component realized by Processor 101. Generating Means 114 generates communication possibility data that indicates what quality of data can be communicated in real time between Terminal Device 12 in which area and Communication Means 112 of System 11 based on position data, communication speed data corresponding to the position data, and correspondence data. Correspondence data is data that indicates a correspondence between a quality of data to be communicated and a communication speed required to communicate the quality data in real time.

Determining Means 115 is a functional component realized by Processor 101. Determining Means 115 determines whether or not Terminal Device 12 of an agent user at a position indicated by agent-position data can transmit data of a quality indicated by quality data to Terminal Device 12 of a client user via Communication Means 112 in real time, based on the quality data indicating the quality of data that the Terminal Device 12 of the client user wants to receive from Terminal Device 12 of the agent user in real time via Communication Means 112, the agent-position data indicating the position from which Terminal Device 12 of the client user wishes to receive the data, and communication possibility data generated by Generating Means 114.

Clocking Means 116 is a functional component realized by Processor 101. Clocking Means 116 continuously clocks the current time.

Storage Means 111 stores the above-mentioned correspondence data in advance. FIG. 4 is a diagram showing a data structure of the correspondence data. The correspondence data illustrated in FIG. 4 is a data table with data fields “Data Quality”, “Communication Speed”, and “Communication Stability Index”. The data field “Data Quality” contains data indicating a quality of video such as “8K video”, “4K video”, etc. The data field “Communication Speed” contains data indicating a communication speed required to transmit data in real time with the quality indicated by the data stored in the data field “Data Quality”. The data field “Communication Stability Index” contains an index (e.g., any natural number from 1 to 10) indicating a degree of communication stability required to transmit in real time data of the quality indicated by the data stored in the data field “Data Quality”.

In data communication between Terminal Device 12 and Communication Means 112 of System 11, if data communication can be performed at a communication speed greater than or equal to a communication speed indicated by the data stored in the data field “Communication Speed”, and if data communication can be performed at a stability greater than or equal to the stability indicated by the data stored in the data field “Communication Stability Index”, Terminal Device 12 can communicate in real-time with Communication Means 112 of System 11 data of the quality indicated by the data stored in the data field “Data Quality”.

When predetermined conditions (described later) are met, Terminal Device 12 transmits position data indicating the current position on the earth (e.g., latitude and longitude) of the Terminal Device 12 to System 11, and also performs data communication with System 11 to measure communication speed. The data communication with System 11 to measure communication speed is, for example, a process of transmitting dummy data of a predetermined data size from Terminal Device 12 to System 11 or from System 11 to Terminal Device 12. System 11 receives position data transmitted from Terminal Device 12 by Communication Means 112, and measures communication speed by Communication-Speed-Calculation Means 113. System 11 associates communication speed data indicating the measured communication speed and the position data, and stores them in Storage Means 111.

The position data transmitted from Terminal Device 12 to System 11 is accompanied by, for example, the following data:
(1) terminal ID, which is data that identifies the Terminal Device 12 from another Terminal Device(s) 12,
(2) model data indicating a model of the Terminal Device 12,
(3) communication medium data indicating a type of communication medium (e.g., wireless, optical cable, etc.) used for data communication between the Terminal Device 12 and System 11,
(4) carrier data indicating a carrier providing a communication line used for the data communication between the Terminal Device 12 and System 11,
(5) provider data indicating a provider of connection services to the Internet in the data communication between the Terminal Device 12 and System 11, and
(6) communication protocol data indicating a type of communication protocol used in the data communication between the Terminal Device 12 and System 11.

The terminal ID in (1) above shall be an identifier that identifies the Terminal Device 12 in the network, such as an e-mail address, in this embodiment. The data listed in (2) through (6) above shall hereinafter be referred to as “communication environment data”. The communication environment data indicates communication environment parameters that affect communication speed or stability of data communication between the Terminal Device 12 and System 11. The data listed in (2) through (6) above is assumed to be used as communication environment data in System 1, but data other than the data listed in (2) through (6) above may be used as communication environment data if they indicate communication environment parameters that affect communication speed or stability in data communication between the Terminal Device 12 and System 11.

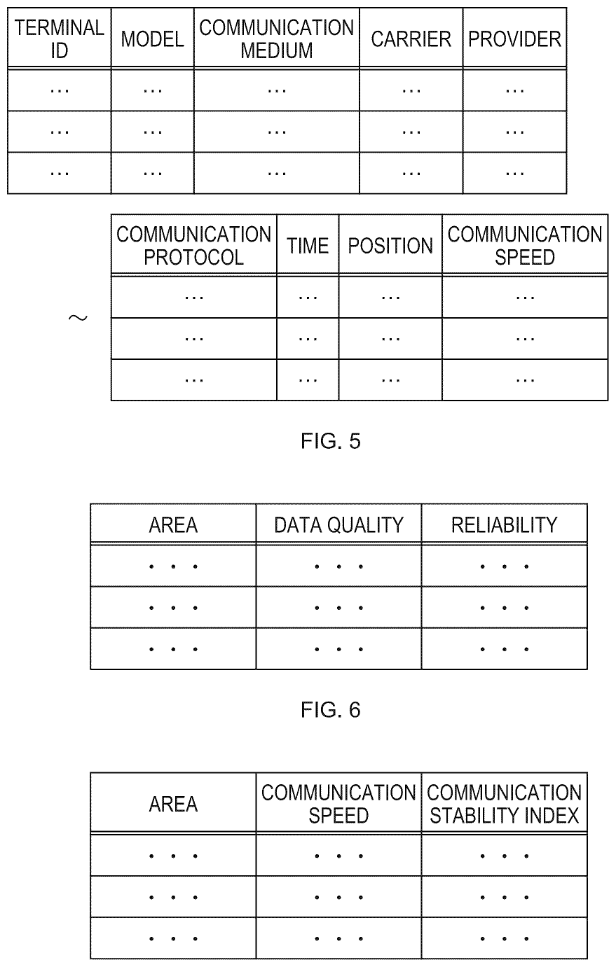

System 11 stores in Storage Means 111 a data table (hereinafter referred to as “log table”) with the data structure shown in FIG. 5. The log table stores position data transmitted from various Terminal Devices 12, data accompanying each of the position data, communication speed data indicating a result of communication speed measurement made upon receipt of each of the position data, and time data indicating a time at which each of the position data was received.

The log table has data fields “Terminal ID”, “Model”, “Communication Medium”, “Carrier”, “Provider”, “Communication Protocol”, “Time”, “Position” and “Communication Speed”. The log table is a collection of data records that store data according to position data transmitted from various Terminal Devices 12 to System 11. Each data field of a data record in the log table stores data according to the name of the data field. The data stored in the data field “Time” is time data indicating the time clocked by Clocking Means 116 at the time Communication Means 112 received the position data from Terminal Device 12.

System 11 generates communication possibility data based on the data stored in the log table by Generating Means 114, for example, at each elapse of a predetermined time. Communication possibility data is generated for each of combinations of the following parameters: model, type of communication medium, carrier, provider, type of communication protocol, type of day, i.e. a day of a week and whether it is a holiday or not, time of day, and weather.

FIG. 6 is a diagram showing a data structure of a communication possibility table. The communication possibility table is a data table for storing communication possibility data generated by System 11. The communication possibility table has data fields “Area”, “Data Quality”, and “Reliability”. The data field “Area” contains data that identifies each of areas of a predetermined shape and size obtained by dividing the area to be served by System 1. The data field “Data Quality” contains data indicating a quality of data, such as “8K video”, “4K video”, etc., that can be communicated in real time between Terminal Device 12 and Communication Means 112 of System 11 in the area indicated by the data stored in the data field “Area”. The data field “Reliability” contains an index (e.g., a natural number from 1 to 10) indicating a level of reliability of the data stored in the data field “Data Quality”.

Storage Means 111 stores data indicating the day of the week and whether or not the day is a holiday (hereinafter referred to as “calendar data”) for each day of a year. Generating Means 114 refers to the calendar data and specifies, for each data record stored in the log table (FIG. 5), a type of day (a day of a week and whether it is a holiday or not) and a time of day at which the position data in the data record is received, based on the time indicated by the data stored in the data field “Time” of the data record.

Generating Means 114 transmits the data stored in the data fields “Position” and “Time” to Server Device 13 for each of the data records stored in the log table (FIG. 5), and receives weather data from Server Device 13 indicating weather at the location and time indicated by the transmitted data.

Generating Means 114 identifies, for each data record stored in the log table (FIG. 5), an area containing the position indicated by the data stored in the data field “Position”.

Generating Means 114 groups the data records stored in the log table (FIG. 5) into groups of data records that contain position data transmitted continuously from a same terminal ID. Then, Generating Means 114 calculates, for each group of data records, an index that indicates a size of variation, e.g., variance, standard deviation, coefficient of variation, etc., in communication speed indicated by the data stored in the data field “Communication Speed” of those data records as an index indicating communication stability (hereinafter referred to as “communication stability index”).

Generating Means 114 adds to the data record of the log table the data indicating the type of day identified above, the weather data received from Server Device 13 as described above, the area data indicating the area identified above, and the communication stability index calculated as described above, and generates training data for a learning model. Data fields of the training data are “Model”, “Communication Medium”, “Carrier”, “Provider”, “Communication Protocol”, “Type of Day”, “Time of Day”, “Weather”, “Area”, “Communication Speed”, and “Communication Stability Index”.

Generating Means 114 constructs a learning model according to a known machine learning method by using data stored in the data fields “Model”. “Communication Medium”, “Carrier”, “Provider”, “Communication Protocol”, “Type of Day”, “Time of Day”, “Weather” and “Area” of the training data generated as described above as explanatory variables, “Day”, “Time of Day”, “Weather” and “Area” as explanatory variables and the data stored in the data fields “Communication Speed” and “Communication Stability Index” as objective variables. The learning model constructed by Generating Means 114 is hereafter referred to as “Learning Model M”.

Generating Means 114, for example, constructs a new Learning Model M every predetermined amount of time, and then generates a communication possibility table (FIG. 6) using the newly constructed Learning Model M. Specifically, Generating Means 114 inputs various combinations of data on “Model”, “Communication Medium”, “Carrier”, “Provider”, “Communication Protocol”, “Type of Day”, “Time of Day”, “Weather” and “Area”, and acquires data on “Communication Speed” and “Communication Stability Index”, which are output from Learning Model M as objective variables. Generating Means 114 stores the acquired data on “Communication Speed” and “Communication Stability Index” in a data table with the data structure shown in FIG. 7 (hereinafter referred to as “working table”). The working table is used to generate the communication possibility table (FIG. 6).

Generating Means 114 specifies a quality of data that can be communicated in real time in each area, by comparing, for each of the data records in the working table (FIG. 7), the communication speed and communication stability index indicated by the data stored in the data fields “Communication Speed” and “Communication Stability Index” with the communication speed and communication stability index indicated by the correspondence data (FIG. 4).

Generating Means 114 specifies the reliability level of the data quality specified for each area based on, for example, a number of data records stored in the log table (FIG. 5) for the area. If Learning Model M outputs data indicating a reliability level of data on “Communication Speed” and “Communication Stability Index” as an objective variable, the reliability level of the data quality specified for each area may be specified based on the data.

Generating Means 114 stores the data indicating data quality and reliability specified above in the communication possibility table (FIG. 6). Generating Means 114 stores data indicating data quality and reliability for all areas to complete the communication possibility table.

The communication possibility table (FIG. 6), which is generated as described above by Generating Means 114, is used to determine possibility of an on-site agency service. System 11 stores a user table, which is a data table for managing data about users of on-site agency services, in Storage Means 111. Users of on-site agency services include both client users and agent users. In other words, a user of System 1 can be either a client user of an on-site agency service or an agent user of the on-site agency service. Users of System 1 do not necessarily need to use on-site agency services. Namely, those who wish to obtain benefits (e.g., points and character data) described below in exchange for providing position data and the communication speed data corresponding to the position data required to generate the communication possibility table (FIG. 6) can also become users of System 1.

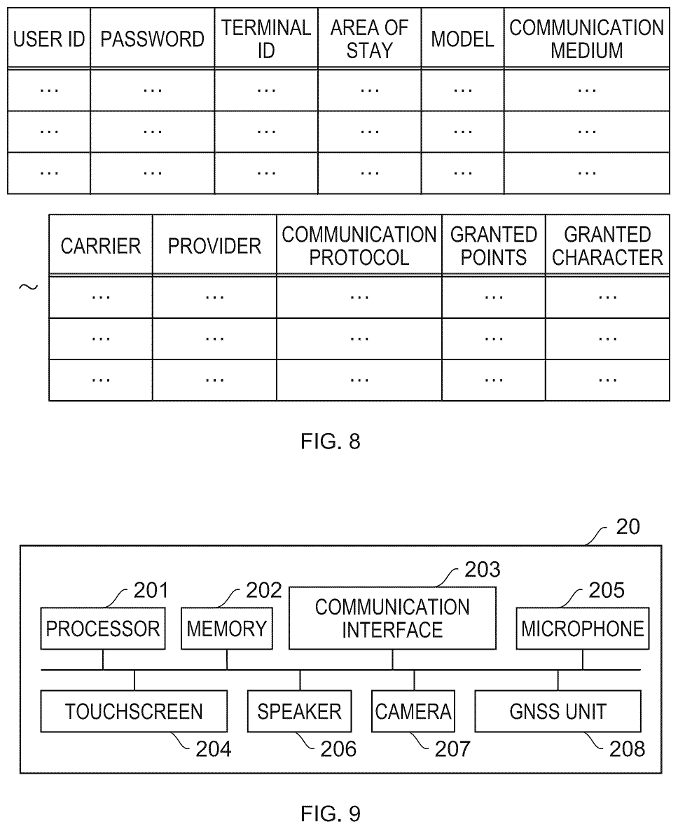

FIG. 8 is a diagram showing a data structure of the user table. The user table is a collection of data records for each user of System 1. The user table has the data fields “User ID”, “Password”, “Terminal ID”, “Area of Stay”, “Model”, “Communication Medium”, “Carrier”, “Provider”, “Communication Protocol”, “Granted Points” and “Granted Character”.

The data field “User ID” contains data identifying a user. The data field “Password” contains data indicating a password for authenticating the user.

The data field “Terminal ID” contains a terminal ID identifying Terminal Device 12 used by the user. The data field “Model” contains data indicating a model of the Terminal Device 12. The data field “Communication Medium” contains data indicating a type of communication medium used for data communication performed by the Terminal Device 12. The data field “Carrier” contains data indicating a carrier that provides a communication line used for data communication performed by the Terminal Device 12. The data field “Provider” contains data indicating a provider of connection services to the Internet in data communication performed by the Terminal Device 12. The data field “Area of Stay” contains data indicating an area where the Terminal Device 12 identified by the terminal ID is usually located (e.g., the area where the user's home is located, the area where user's workplace is located, etc.). If a user is using more than one Terminal Device 12 (e.g., a desktop PC and a smartphone, etc.), the data fields “Terminal ID”, “Area of Stay”, “Model”, “Communication Medium”, “Carrier”, “Provider” and “Communication Protocol” will be stored for each of those two or more Terminal Devices 12.

The data field “Granted Points” contains data indicating a number of remaining points that are granted to the user. Points in this embodiment serve a monetary role that can be used to purchase goods and services, for example. In this embodiment, points are granted to Terminal Device 12 when a user of Terminal Device 12 goes to an area where communication speed data is insufficient, as described later.

The data field “Granted Character” contains data identifying character data that is granted to the user. Character data is data that represents, for example, images and sounds of characters such as people, animals, etc. In this embodiment, character data is also granted to Terminal Device 12 when a user of Terminal Device 12 goes to an area where communication speed data is insufficient, as described later.

Terminal Device 12 is realized by a general computer for a terminal device. The computer used as Terminal Device 12 can be any type of computer, such as a desktop PC, notebook PC, tablet PC, smartphone, wearable device, etc.

FIG. 9 is a diagram showing a configuration of Computer 12, a tablet PC, as an example of a computer used as Terminal Device 12. Computer 20 comprises Processor 201 that processes various data according to a program, Memory 202 that stores various data including the program, Communication Interface 203 that performs data communication with other data communication devices, Touchscreen 204 that serves as a user interface, Microphone 205 that picks up sound, Speaker 206 that emits sound, Camera 207 that takes pictures, and GNSS Unit (Global Navigation Satellite System Unit) 208 that measures positions on the earth, e.g., latitude and longitude, of Computer 20.

Touchscreen 204 is a device comprising, for example, a liquid crystal display that displays images and other information to the user and a touch panel that accepts touch operations performed by the user.

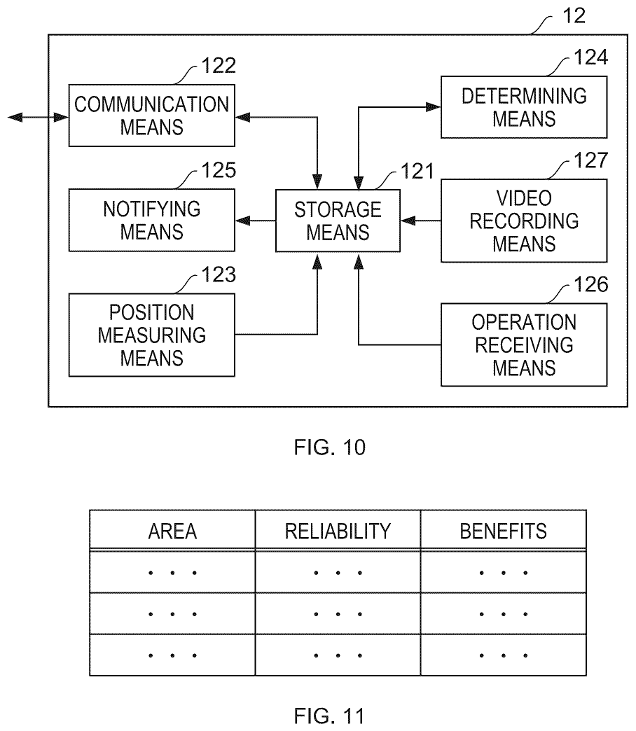

FIG. 10 is a diagram showing a functional configuration of Terminal Device 12. Processor 201 of Computer 20 processes data according to the program for Terminal Device 12 to realize Terminal Device 12, which has the functional components shown in FIG. 10. The functional components of Terminal Device 12 are described below.

Storage Means 121 is a functional component realized by Memory 202, which operates under the control of Processor 201. Storage Means 121 stores various data.

Communication Means 122 is a functional component realized by Communication Interface 203, which operates under the control of Processor 201. Communication Means 122 communicates various data with System 11.

Position Measuring Means 123 is a functional component realized by GNSS UNIT 208, which operates under the control of Processor 201. Position Measuring Means 123 receives navigation signals from multiple satellites and measures a position on the earth (i.e. latitude and longitude) of its own device based on the received navigation signals.

Determining Means 124 determines whether the current position of the device is in an area with insufficient communication speed data. Determining Means 124 makes the determination by using insufficient area data that Communication Means 122 receives from System 11 and position data indicating a position of its own device measured by Position Measuring Means 123. Insufficient area data is data indicating areas where a number of communication speed data that System 11 acquires is insufficient.

FIG. 11 is a diagram showing a data structure of insufficient area table that is a data table for storing the insufficient area data. The insufficient area table is generated by Generating Means 114 of System 11 for each combination of model, communication medium, etc., similar to the communication possibility table (FIG. 6).

The insufficient area table has data fields “Area”, “Reliability” and “Benefits”. Data contained in the data fields “Area” and “Reliability” in the insufficient area table are copies of data contained in the data fields “Area” and “Reliability” in the communication possibility table (FIG. 6). The data field “Reliability” indicates a number of communication speed data for the corresponding area. In other words, when data stored in the data field “Reliability” indicates a low reliability, it means that System 11 has acquired a small number of communication speed data for an area corresponding to the data record. In this embodiment, as an example, a reliability level is expressed as a natural number from 1 to 10, and an area where the reliability level is equal to or less than 7 is assumed to be an area where communication speed data is insufficient (hereinafter referred to as an “insufficient area”).

Generating Means 114 of System 11, for example, extracts from the communication possibility table data records whose data stored in the data field “Reliability” is equal to or less than 7 each time, then the communication possibility table is updated. Generating Means 114 then reads the data stored in the data fields “Area” and “Reliability” of the extracted data records and generates a copy of them as a new insufficient area table.

Generating Means 114 then adds the data field “Benefits” to the new generated insufficient area table and stores benefit data in the added data field “Benefits”. The benefit data is data that indicates contents of the benefits. In this embodiment, benefits shall be points or character data, and the more often that a user goes to an area with a lower reliability level, the more points or the less frequent character data is provided to the user.

When the benefit data is stored in the data field “Benefits” and a new insufficient area table is completed as described above, Communication Means 112 reads, for each Terminal Device 12, the terminal ID (e-mail address) from the user table (FIG. 8), and transmits an insufficient area table according to a combination of model, communication medium, etc. of the Terminal Device 12 to the terminal ID.

Notifying Means 125 (see FIG. 10) of Terminal Device 12 is a functional component realized by Touchscreen 204 (display portion) and Speaker 206, which operate under the control of Processor 201. Notifying Means 125 provides various types of notifications to the user by displaying images and emitting sounds.

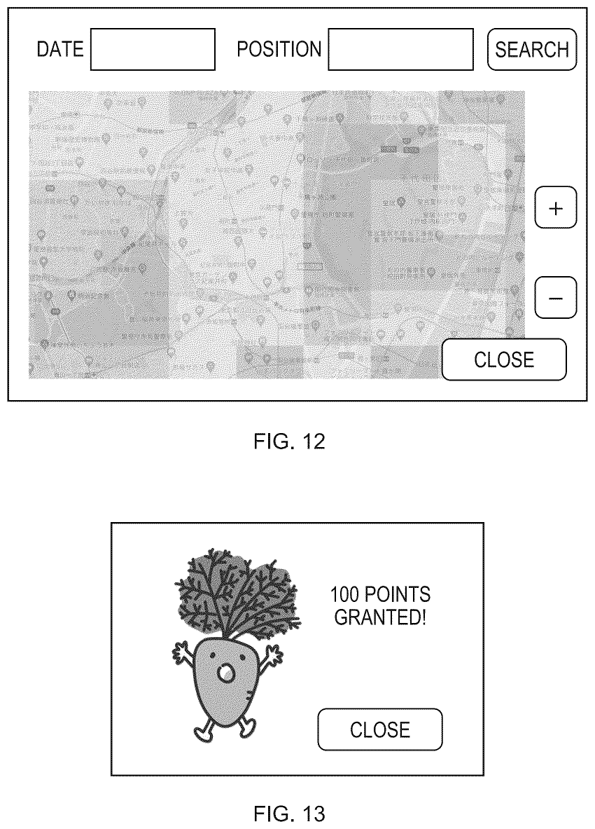

For example, Notifying Means 125 displays a screen as illustrated in FIG. 12 (hereinafter referred to as “rare-character-appearance-area-map screen”) using the insufficient area table in response to a predetermined operation made by the user. The rare-character-appearance-area-map screen is a screen that displays an image called a heat map, in which areas identified by data stored in the insufficient area table in a map represented by map data stored in advance by Terminal Device 12 is shown in a color (or density) corresponding to the reliability levels of the areas.

On the rare-character-appearance-area-map screen, users can specify a date, time, and position to see a heat map for the specified date, time, and position. On the rare-character-appearance-area-map screen, users can change a scale of the heat map by touching “+” button or “−” button. The heat map displayed on the rare-character-appearance-area-map screen allows users to know the areas where they can obtain high points or rare character data.

Determining Means 124 (see FIG. 10) monitors changes over time in the position of Terminal Device 12, which is continuously measured by Position Measuring Means 123. When Determining Means 124 detects that the location of Terminal Device 12 is newly included in one of the areas shown in the insufficient area table (FIG. 11), it passes a notification of the event (hereinafter referred to as “insufficient-area-entry notification”) to Communication Means 122 and Notifying Means 125.

When Communication Means 122 receives an insufficient-area-entry notification from Determining Means 124, it communicates data (e.g., dummy data of a predetermined data size) for communication speed measurement with Communication Means 112 of System 11. Communication Means 112 and Communication Means 122 measure a communication speed in their communication. The communication speed data, which indicates the communication speed measured by Communication Means 112 and Communication Means 122, is stored in a log table (FIG. 5) along with data indicating various conditions (area, date and time, etc.) under which the communication was performed. This allows System 11 to acquire communication speed data for areas where communication speed data is insufficient.

When Communication Means 122 receives an insufficient-area-entry notification from Determining Means 124, it refers to the insufficient area table (FIG. 11) and displays benefits corresponding to the area to which the current position of Terminal Device 12 belongs and emits a sound to notify that the benefits have been granted.

FIG. 13 is a diagram showing a screen that Notifying Means 125 displays when benefits are granted (hereinafter referred to as a “granted-benefit-notification screen”). The granted-benefit-notification screen displays benefits (points and character data) granted to the user for entering an area with insufficient communication speed data. The data related to the benefits granted to the user are reflected in the user table (FIG. 8) in System 11.

Operation Receiving Means 126 (see FIG. 10) is a functional component realized by Touchscreen 204 (touch panel portion), which operates under the control of Processor 201. Operation Receiving Means 126 receives operations performed by the user on Terminal Device 12.

Video Recording Means 127 is a functional component realized by Camera 207 and Microphone 205, which operate under the control of Processor 201. Video Recording Means 127 captures images representing the surrounding situation of Terminal Device 12 and picks up ambient sound, and generates video data representing video with sound.

System 11 has the following functions using the communication possibility table (FIG. 6): (1) to determine whether a client user is able to video record the desired site by having one of agent users do so on his/her behalf, and (2) if the video recording is possible, to receive applications from agent users who are willing to undertake the on-site video recording.

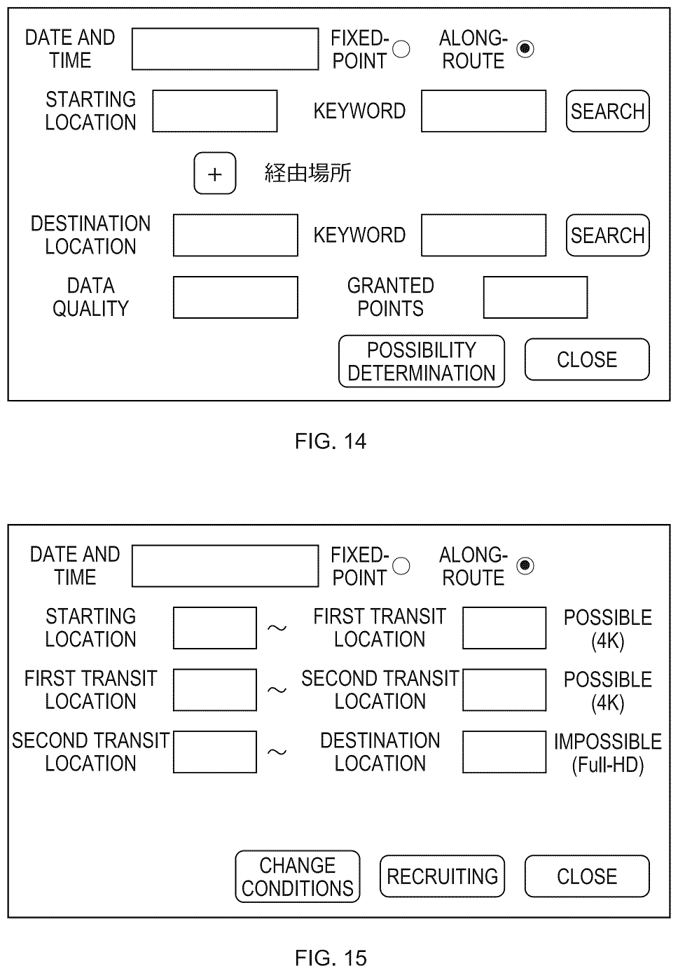

FIG. 14 is a diagram showing an example of a screen (hereinafter referred to as a “request-reception screen”) where a client user enters conditions for his/her desired on-site video recording, confirms whether or not the on-site video recording is possible, and, if so, applies for an agent user who will undertake the on-site video recording on his/her behalf.

The client user performs a prescribed operation on his/her Terminal Device 12 to display the request-reception screen, enters his/her desired conditions on the request-reception screen, and then touches the “Possibility Determination” button. The desired conditions may include: desired date and time of on-site video recording; whether video recording is carried out at one specified location (fixed-point video recording) or while moving along a specified route (along-route video recording); video recording location in the case of fixed-point video recording; starting location, transit locations, and destination location in the case of along-route video recording; desired quality of data (8K video, 4K video, etc.); number of points granted to the agent user; whether rehearsal is required or not.

The client user can easily input information on the desired location for video recording by entering search keywords in the keyword input field and touching the “Search” button on the request-reception screen to display a list of location names corresponding to the search keywords, and then selecting the desired location from the list.

When the “Possibility Determination” button on the request-reception screen is touched by the client user, various data indicating the conditions for video recording entered by the client user on the request-reception screen (hereinafter referred to as “on-site video recording condition data”) is transmitted from Terminal Device 12 to System 11. Determining Means 115 of System 11 determines whether a data quality that can be communicated in real time in the area including the video recording location indicated by the on-site video recording condition data (in the case of fixed-point shooting) or in each area along the route (in the case of along-route video recording) is higher than the quality of data desired by the client user indicated by the on-site video recording condition data, based on the communication possibility table (FIG. 6) corresponding to a combination of model, communication medium, and other conditions indicated by the on-site video recording condition data.

When the on-site video recording condition data indicates that along-route video recording is selected, Determining Means 115 transmits data to Server Device 14 indicating the starting location, transit locations and destination location of the specified route, and designated date and time, and receives route data, which is time series data of latitude and longitude indicating the route, from Server Device 14. Determining Means 115 uses the route data to make the above determination.

System 11 transmits determination result data indicating a result of the determination made by Determining Means 115 to Terminal Device 12. Terminal Device 12 displays a screen (hereinafter referred to as the “determination-result-notification screen”), which notifies the client user of possibility of on-site video recording, using the determination result data which is transmitted from System 11 in response to user's touch of the “Possibility Determination” button on the request-reception screen (FIG. 14).

FIG. 15 is a diagram showing the determination-result-notification screen. The determination-result-notification screen displays a possibility of on-site video recording of the desired data quality and the maximum possible data quality of the on-site video recording, with respect to the location for video recording (in the case of fixed-point shooting) or for each location on the route for video recording (e.g., a section from the starting location to the first transit location, a section from the first transit location to the second transit location, a section from the second transit location to the destination location, etc.).

The determination-result-notification screen displays a “Change Conditions” button and a “Recruiting” button. The “Recruiting” button accepts touch operation only when it is determined that on-site video recording is possible (in the case of along-route shooting, on-site video recording is possible in all sections).

If the client user wishes to change the conditions of the on-site video recording (e.g., change the desired data quality) based on the information displayed on the determination-result-notification screen, he/she can touch the “Change Conditions” button to redisplay the request-reception screen (FIG. 14) to change the conditions of the on-site video recording.

If the client user does not need to change the conditions of the on-site video recording and would like an agent user to undertake the on-site video recording on his/her behalf, the client user touches the “Recruiting” button.

When the “Recruiting” button on the determination-result-notification screen is touched, Terminal Device 12 transmits recruitment data indicating the conditions of recruitment of an agent user for the on-site video recording to System 11. The recruitment data includes the on-site video recording condition data.

When System 11 receives the recruitment data from Terminal Device 12, Determining Means 115 of System 11 extracts from the user table (FIG. 8), for example, data records of users who can perform the on-site video recording under the conditions indicated by the on-site video recording condition data included in the recruitment data. For each of the extracted data records, System 11 transmits recruitment notification data to the terminal ID, notifying that there has been a call for the on-site video recording. The recruitment notification data includes the on-site video recording condition data.

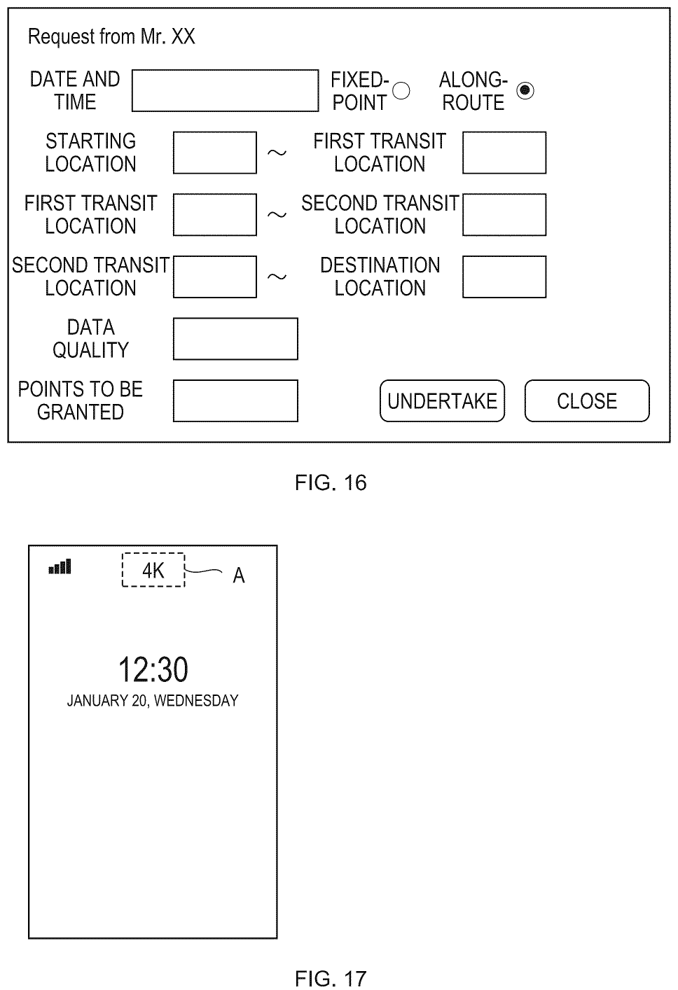

Upon receiving the recruitment notification data, Terminal Device 12 displays a screen (hereinafter referred to as “recruitment-notification screen”) for acceptance of a request for on-site video recording by the agent user. FIG. 16 is a diagram showing the recruitment-notification screen.

The user checks the conditions of the on-site video recording shown on the recruitment-notification screen and touches the “Undertake” button if he/she wishes to undertake the request. In response to the touch of the “Undertake” button, Terminal Device 12 transmits undertaking data to System 11, indicating that the user is undertaking the request for on-site video recording. When System 11 receives the undertaking data from one of the Terminal Devices 12, it transmits acceptance notification data to the client user's Terminal Device 12, notifying that the request was accepted by the user (agent user) of Terminal Device 12 from which the undertaking data was transmitted. This means that an agreement has been reached between the client user and the agent user regarding the on-site video recording.

System 11 transmits data for establishing a communication session (e.g., URL, etc.) (hereinafter referred to as “data for establishing a communication session”) to each of Terminal Devices 12 of the client user and agent user for communicating data in real time between them. In this embodiment, the communication session established between the client user's Terminal Device 12 and the agent user's Terminal Device 12 shall be a communication session via System 11.

When the start time of the on-site video recording approaches, the client user and the agent user establish a communication session between their Terminal Devices 12 using the data for establishing a communication session, so that they can make video calls with each other. The agent user then performs the on-site video recording using his/her Terminal Device 12 according to the conditions designated by the client user. The client user can view the situation at the site being filmed by the agent user in real time by watching the video with sound that is played by his/her Terminal Device 12.

When the on-site video recording is completed and the client user performs a predetermined operation on Terminal Device 12, the Terminal Device 12 transmits end-of-video recording notification data to System 11, notifying that the on-site video recording is completed. When System 11 receives the end-of-video recording notification data, it updates the user table (FIG. 8) so that the points of the client user are moved to the agent user by the number of points indicated by the on-site video recording condition data for the on-site video recording indicated by the end-of-video recording notification data.

The above is a description of System 1. According to System 1 described above, communication possibility data can be obtained, which indicates what quality of data, in which area, can be communicated in real time under various models of terminal devices, communication media, and other conditions. The communication possibility data obtained by System 1 can be used by, for example, a carrier providing communication lines to improve its services.

According to System 1 described above, the client user can know in advance whether or not the desired on-site video recording can be performed by an agent user on his/her behalf. Since the recruitment notification data for the on-site video recording is transmitted only to Terminal Devices 12 of users who can perform the on-site video recording under the conditions designated by the client user, a situation is avoided where a user who is unable to perform the requested on-site video recording, due to, for example, his/her Terminal Device 12 having insufficient capability for communication or video recording, to mistakenly undertake the request.

### MODIFIED EXAMPLES

System 1 described above may be modified in various ways within the scope of the technical idea of the present invention. Example modifications are shown below. Two or more of the following modified examples may be combined as appropriate.

(1) In the embodiment described above, the communication session established between Terminal Devices 12 of the client user and the agent user is assumed to be a communication session via System 11. The communication possibility data stored in the communication possibility table (FIG. 6) is data generated based on communication speed data indicating communication speed measured between various Terminal Devices 12 and System 11. In this case, if the communication between Terminal Devices 12 of the client user and the agent user is performed via System 11 rather than without System 11, reliability of a result of the determination on whether on-site video recording is possible or not based on the communication possibility data is increased.

On the other hand, if the communication between Terminal Devices 12 of the client user and the agent user is performed via System 11, high performance is required for System 11 and the communication network connected to System 11. Thus, for example, if a large number of Terminal Devices 12 perform data communication via System 11 and the performance of System 11 or the communication network connected to System 11 is insufficient, on-site video recording that has been determined to be possible may become impossible. Therefore, the communication between Terminal Devices 12 of the client user and the agent user may be performed without going through System 11.

(2) In the embodiment described above, the communication possibility data stored in the communication possibility table (FIG. 6) is assumed to be data generated based on communication speed data indicating communication speed measured between various Terminal Devices 12 and System 11. In this case, the load on System 11 is increased to measure communication speed. Therefore, to reduce the load on System 11, each Terminal Device 12 may access a server device that provides a communication speed measurement service that does not belong to System 11, and measure communication speed by communicating data with the server device. In this case, each Terminal Device 12 or the server device should transmit communication speed data indicating the measurement results to System 11, together with data indicating the various conditions (model, communication medium, etc.) under which the communication was performed.

(3) In the embodiment described above, a communication speed when data is transmitted from Terminal Device 12 to System 11 (hereinafter referred to as an “upstream communication speed”) and a communication speed when data is transmitted from System 11 to Terminal Device 12 (hereinafter referred to as a “downstream communication speed”) are not distinguished. In many communication networks to which Terminal Devices 12 connect, an upstream communication speed is slower than a downstream communication speed. In System 1, Terminal Device 12 of the agent user mainly uploads data, and Terminal Device 12 of the client user mainly downloads data. Therefore, upstream communication speed, which is the bottleneck in determining whether the on-site video recording in System 1 is possible or not, is more important than downstream communication speed. Accordingly, only an upstream communication speed may be measured, and the communication possibility data may be generated based only on the measured upstream communication speed.

However, a configuration in which both upstream and downstream communication speeds are measured and the communication possibility data is generated based on the results of these measurements may be adopted. For example, if a data quality of a video call between Terminal Devices 12 of the client user and the agent user should be kept low, while a data quality of video data with sound that is transmitted from Terminal Device 12 of the agent user to Terminal Device 12 of the client user should be high, an upstream communication speed of Terminal Device 12 of the agent user and a downstream communication speed of Terminal Device 12 of the client user are important in determining whether the on-site video recording is possible or not.

Therefore, when the client user touches the “Possibility Determination” button on the request-reception screen (FIG. 14), System 11 may use communication possibility data generated based on downstream communication speed of Terminal Device 12 to determine whether on-site video recording is possible or not, and when the client user touches the “Recruiting” button on the determination-result-notification screen (FIG. 15), System 11 may use communication possibility data generated based on upstream communication speed of Terminal Device 12 to extracts candidate users for the agent user.

(4) In the embodiment described above, the type of data transmitted from Terminal Device 12 of the agent user to Terminal Device 12 of the client user in real time is assumed to be video data with sound. Types of data other than video data with sound may be transmitted from Terminal Device 12 of the agent user to Terminal Device 12 of the client user in real time. For example, while Terminal Device 12 of the agent user is in a poor communication environment, instead of video data with sound, still image data, sound data without video data, text data, etc. may be transmitted from Terminal Device 12 of the agent user to Terminal Device 12 of the client user in real time.

(5) In the embodiment described above, System 11 acquires communication speed data by calculating a communication speed with Terminal Device 12. Alternatively, Terminal Device 12 may calculate the communication speed and transmit communication speed data indicating the calculated communication speed to System 11. In this case, System 11 acquires communication speed data by receiving it from Terminal Device 12.

(6) In the embodiment described above, the missing communication speed data is assumed to be complemented using a learning model constructed by machine learning. Instead, other methods such as statistical processing may be used to complement missing communication speed data.

(7) With respect to the model used as one of the parameters affecting communication speed in the embodiment described above, specifications of the model of Terminal Device 12 such as processor capability, communication unit capability, etc. may be used instead of just the name of the model. In this case, for Terminal Device 12 whose communication speed has not been measured, the communication speed can be estimated based on communication speeds of Terminal Devices 12 with specifications similar to those of the Terminal Device 12 whose communication speed has not been measured.

(8) In the embodiment described above, insufficient area data is assumed to be data indicating areas where communication speed data acquired by System 11 is insufficient, regardless of whether or not communication service is provided in each area. Alternatively, areas where communication services are not provided may be excluded from areas indicated by the insufficient area data.

For example, carriers who provide mobile communication services usually publish maps showing areas where radio waves for communication reach. For areas that the map indicates that radio waves for communication cannot reach, a communication speed must be 0. Therefore, by excluding areas where communication is not possible from the area indicated by the insufficient area data, a situation where users to go to the areas for measuring communication speeds in vain is avoided.

(9) In the embodiment described above, it is assumed that a user who goes to an area indicated by insufficient area data (an area where the communication speed data acquired by System 11 is insufficient) can always earn benefits. For example, if a user passes through the area in a short time and the communication speed measurement in the area is not completed, the objective of acquiring communication speed data is not achieved. Therefore, benefits may be granted to the user only when the communication speed measurement is completed. For example, before the benefits are granted, a character indicated by the character data included in the benefits may talk to the user from Terminal Device 12 to encourage the user to stay in the area during the communication speed measurement.

(10) In the embodiment described above, a user of Terminal Device 12 is assumed to be a human. A user using Terminal Device 12 may be a device. In such a case, Terminal Device 12 and the device that plays the role of the user may be integrated as a single device. For example, the client user may be a device equipped with artificial intelligence. The agent user may be a device such as a robot that can move autonomously.

(11) In the embodiment described above, it is assumed that benefits granted to users who contribute to the measurement of communication speeds are points and character data. Types of benefits are not limited to points and character data. For example, real currency, electronic money, virtual currency, goods, etc. may be granted to users as benefits. Moreover, the means of payment from the client user to the agent user is not limited to points. The payment may be made in real currency, electronic money, virtual currency, goods, etc.

(12) In the embodiment described above, a recipient of benefits granted for a measurement of communication speed is a user of Terminal Device 12 who measured the communication speed. The recipient of the benefits is not limited to the user of Terminal Device 12 who measured the communication speed. For example, System 11 may allow each user to register recipients of benefits, and benefits may be granted to the registered recipients when communication speed is measured by Terminal Device 12 of the user. Moreover, benefits may be distributed to multiple users who contributed to measurement of communication speeds. In such a case, distribution rates or distribution amount among multiple grantees may be registered in System 11, and an amount of benefits according to the distribution rate or the distribution amount may be granted to each of the grantees.

(13) A client user may evaluate an agent user, and the evaluation results may be viewable to other users.

(14) Terminal Device 12 may take into account the effects of communication performed according to programs running in the background when measuring communication speed. For example, a result of communication speed measurement performed by Computer 20 according to the program of this invention may be modified based on communication speed in communications performed by Computer 20 according to programs other than the program of this invention. Computer 20 may not perform communication speed measurement according to the program of this invention if communication speed in communications performed by Computer 20 according to programs other than the program of this invention is above a predetermined threshold.

(15) If a potential agent user of the on-site agency service can easily know what quality of data can be communicated in real time in what area, how stable the communication speed is, and how reliable this information is, he/she can easily determine whether the request is feasible for him/her when he/she receives a recruitment notification. Accordingly, Terminal Device 12 may display on the screen information such as quality of data, stability of communication, reliability of this information, etc. with regard to real time communication at the current position of the Terminal Device 12.

FIG. 17 is a diagram showing a screen where Terminal Device 12 displays a quality of data that can be communicated in real time at the current position of the Terminal Device 12. In the screen shown in FIG. 17, text and other information indicating the quality of data that can be communicated in real time at the current position of the Terminal Device 12 are displayed in area A. The example shown in FIG. 17 shows that Terminal Device 12 is capable of communicating 4K quality video data in real time at the current position of the Terminal Device 12. It is desirable for the quality of data to be displayed at any time, even when Computer 20 is running the program of this invention in the background. However, it may be the case that the quality of data is displayed only when the user performs a predetermined operation on Terminal Device 12.

Terminal Device 12 transmits position data indicating the current position of the Terminal Device 12, for example, at predetermined time intervals, together with a terminal ID of the Terminal Device 12 to System 11 for displaying the quality of data in Area A of the screen shown in FIG. 17. When System 11 receives the terminal ID and position data from Terminal Device 12, it specifies parameters of communication environment, such as model of Terminal Device 12, communication medium, etc. from the user table (FIG. 8). System 11 then specifies a data quality that can be communicated in real time in the area including the position indicated by the position data received from Terminal Device 12, based on the communication possibility table (FIG. 6) corresponding to the specified parameters. System 11 transmits quality data indicating the specified data quality to Terminal Device 12 from which the terminal ID and position data were transmitted. Terminal Device 12 displays in area A of the screen shown in FIG. 17 the quality of data indicated by the quality data transmitted from System 11 in response to the transmission of the terminal ID and position data.

As described above, if Terminal Device 12 is configured to communicate with System 11 at predetermined time intervals in order to display the quality of data in area A, a large communication fee may be incurred for the user of Terminal Device 12. To avoid such inconvenience, all or part of the communication possibility table (FIG. 6) (e.g., the area where Terminal Device 12 is located and the part related to the area within a certain distance from the area where Terminal Device 12 is located) may be downloaded from System 11 and stored during the period when Terminal Device 12 is in a communication environment where no (or low) communication fees are incurred, such as where a WiFi connection is available. In this case, Terminal Device 12 may specify the quality of data that can be communicated in real time at the current position of the Terminal Device 12 based on the communication possibility table stored in the Terminal Device 12, and display the specified quality of data in area A of the screen.

On the screen shown in FIG. 17, the quality of data that can be communicated in real time is displayed. Instead of or in addition to the quality of data, other information such as stability of communication, reliability of information, etc. may be displayed on the screen. For example, Terminal Device 12 may determine whether or not data communication of a specific quality (e.g., Full-HD video) can be performed in real time according to predetermined rules based on communication speed, stability, and reliability, and display the result of the determination, such as “Full-HD video is possible”, “Full-HD video is not possible”, etc.

(16) In the embodiment described above, it is assumed that communication speed measurement is automatically started when Terminal Device 12 enters an area where communication speed data is insufficient according to the insufficient area table (FIG. 11). Alternatively, Terminal Device 12 may perform communication speed measurement after the user performs a predetermined operation to start communication speed measurement on Terminal Device 12. When Terminal Device 12 automatically performs the measurement of communication speed, an upper limit of data volume that can be used to measure communication speed (e.g., up to 10 GB per month, etc.) may be registered to Terminal Device 12, and Terminal Device 12 may perform the measurement of communication speed only when data volume of communications made for measuring communication speeds in the past is below the upper limit.

1. A system comprising:
a storage means for storing correspondence data indicating a correspondence between a quality of data to be communicated and a communication speed required to communicate data having the quality in real time;
an acquisition means for acquiring position data indicating a position of a terminal device and communication speed data indicating a communication speed in data communications made by a terminal device at a position indicated by the position data with a communication partner device; and
a generating means for generating communication possibility data indicating what quality of data, in which area, can be communicated in real time between a terminal device and a communication partner device based on the position data, the communication speed data corresponding to the position data, and the correspondence data.

2. The system according to claim 1, further comprising:
a communication means for data communication with a terminal device,
wherein, the communication speed data acquired by the acquisition means indicates a communication speed in data communications made by the communication means with a terminal device at a position indicated by the position data.

3. The system according to claim 1,
wherein,
the acquisition means acquires, in addition to the position data and the communication speed data corresponding to the position data, time data indicating a time when a terminal device at a position indicated by the position data communicated with a communication partner device at a communication speed indicated by the communication speed data, and
the generating means generates the communication possibility data for each of a plurality of time periods that divide a day based on the time data.

4. The system according to claim 3,
wherein,
the storage means stores calendar data indicating a date, a day of a week, and whether the date is a holiday or not, and
the generating means generates the communication possibility data for each day of a week and whether a day is a holiday or not based on the calendar data.

5. The system according to claim 2,
wherein,
the communication means receives from a server device weather data indicating weather at a position indicated by the position data at a time indicated by the time data corresponding to the position data, and
the generating means generates the communication possibility data for each type of weather based on the weather data.

6. The system according to claim 1,
wherein,
the acquisition means acquires, in addition to the position data and the communication speed data corresponding to the position data, communication environment data indicating communication environment parameters including at least one of a model of a terminal device at a position indicated by the position data, a type of communication medium used for data communication between a terminal device and a communication partner device at a communication speed indicated by the communication speed data, a carrier providing a communication line used for the data communication, a provider of connection services to the Internet in the data communication, and a type of communication protocol used in the data communication.

7. The system according to claim 1,
wherein,
the correspondence data indicates a correspondence between a quality of data to be communicated, a communication speed required to communicate data having the quality in real time, and a communication stability index indicating communication stability required for real-time communication of data having the quality,
the acquisition means continuously acquires position data and communication speed data corresponding to the position data for a same terminal device, and
the generating means calculates the communication stability index for each area for the same terminal device based on the communication speed data corresponding to the position data indicating a position in each area, and generates the communication possibility data based on the correspondence data and the communication stability index.

8. The system according to claim 1,
wherein,
the generating means has a learning model constructed by machine learning using training data including position data as an explanatory variable and communication speed data as an objective variable, and generates the communication possibility data using communication speed data output by the learning model as an objective variable when position data acquired by the acquisition means is input to the learning model as an explanatory variable.

9. A system comprising:
a storage means for storing communication possibility data indicating what quality of data, in which area, can be communicated in real time between a terminal device in a specific area and a communication partner device,
a receiving means for receiving position data indicating a position from a terminal device,
an identifying means for identifying a quality of data that can be communicated in real time with a communication partner device by a terminal device at a position indicated by the position data received by the receiving means based on the communication possibility data, and
a transmitting means for transmitting quality data indicating the quality identified by the identifying means to a terminal device from which the position data received by the receiving means is transmitted.

10. The system according to claim 9,
wherein,
the storage means stores a plurality of sets of the communication probability data according to contents of communication environment parameters, the communication environment parameters including at least one of a model of a terminal device, a type of communication medium used for data communication between the terminal device and a communication partner device, a carrier providing a communication line used for the data communication, a provider of connection services to the Internet in the data communication, and a type of communication protocol used in the data communication,
the receiving means receives communication environment data indicating contents of communication environment parameters of a terminal device from which the position data is transmitted, and
the identifying means identifies the quality based on the communication possibility data corresponding to contents of communication environment parameters indicated by the communication environment data received by the receiving means.

11. A system comprising:
a storage means for storing communication possibility data indicating what quality of data can be communicated in real time between a terminal device in a specific area and a communication partner device,
a receiving means for receiving, from a terminal device, position data indicating a position and quality data indicating a quality of data that the terminal device wishes to communicate in real time with a communication partner device,
a determining means for determining, based on the communication possibility data, whether or not the terminal device can communicate data of a quality indicated by the quality data with a communication partner device in real time at a position indicated by the position data, and
a transmitting means for transmitting determination result data indicating a result of a determination made by the determining means to a terminal device from which the position data and quality data received by the receiving means are transmitted.

12. The system according to claim 11,
wherein,
the storage means stores a plurality of sets of the communication probability data according to contents of communication environment parameters, the communication environment parameters including at least one of a model of a terminal device, a type of communication medium used for data communication between the terminal device and a communication partner device, a carrier providing a communication line used for the data communication, a provider of connection services to the Internet in the data communication, and a type of communication protocol used in the data communication,
the receiving means receives communication environment data indicating contents of communication environment parameters of a terminal device from which the position data is transmitted, and
the determining means makes the determination based on the communication possibility data corresponding to contents of communication environment parameters indicated by the communication environment data received by the receiving means.

13. A terminal device communicating with the system according to claim 1, comprising:
a communication means for receiving insufficient area data indicating areas with insufficient communication speed data being obtained by the system,
a storage means for storing the insufficient area data,
a position measuring means for measuring a position of the terminal device, and
a determining means for determining whether or not a position of the terminal device measured by the position measuring means is included in an area indicated by the insufficient area data,
wherein,
when the determining means determines that the position of the terminal device is included in an area indicated by the insufficient area data, the communication means transmits position data indicating the position of the terminal device measured by the position measuring means to the system, and makes data communication with the system to measure a communication speed of the system.

14. The terminal device according to claim 13, further comprising:
a notifying means for notifying, when the determining means determines that the position of the terminal device is included in an area indicated by the insufficient area data, a grant of benefit.

15. A program for causing a computer to execute:
storing correspondence data indicating a correspondence between a quality of data to be communicated and a communication speed required to communicate data having the quality in real time;
acquiring position data indicating a position of a terminal device and communication speed data indicating a communication speed in data communications made by a terminal device at a position indicated by the position data with a communication partner device; and
generating communication possibility data indicating what quality of data can be communicated in real time in which area between a terminal device and a communication partner device based on the position data, the communication speed data corresponding to the position data, and the correspondence data.

16. A program for causing a computer to execute:
storing communication possibility data indicating what quality of data can be communicated in real time between a terminal device in a specific area and a communication partner device,
receiving position data indicating a position from a terminal device,
identifying a quality of data that can be communicated in real time between a terminal device at a position indicated by the position data and a communication partner device based on the communication possibility data, and
transmitting quality data indicating the identified quality of data to a terminal device from which the position data is transmitted.

17. A program for causing a computer to execute:
storing communication possibility data indicating what quality of data can be communicated in real time between a terminal device in a specific area and a communication partner device,
receiving, from a terminal device, position data indicating a position and quality data indicating a quality of data that the terminal device wishes to communicate in real time with a communication partner device,
determining, based on the communication possibility data, whether or not the terminal device can communicate data of a quality indicated by the quality data with a communication partner device in real time at a position indicated by the position data, and
transmitting determination result data indicating a result of the determination to a terminal device from which the position data and quality data are transmitted.

18. A program for causing a computer communicating with the system according to claim 1 to execute:
receiving insufficient area data indicating areas with insufficient communication speed data being obtained by the system,
storing the insufficient area data,
measuring a position of the computer,
determining whether or not the measured position of the computer is included in an area indicated by the insufficient area data, and
when it is determined that the position of the computer is included in an area indicated by the insufficient area data, transmitting position data indicating the measured position of the computer to the system, and making data communications with the system to measure a communication speed with the system.
